(19) United States
(12) Patent Application Publication
(10) Pub. No.: US 2014/0047722 A1
(43) Pub. Date: Feb. 20, 2014

(54) CHAIN SAW

(71) Applicant: HITACHI KOKI CO., LTD., Tokyo (JP)

(72) Inventors: Miyoji Onose, Ibaraki (JP); Ai Nakayama, Ibaraki (JP); Seiichi Kodato, Ibaraki (JP); Kouji Sagawa, Ibaraki (JP); Shinichi Kakefuda, Ibaraki (JP)

(73) Assignee: HITACHI KOKI CO., LTD., Tokyo (JP)

(21) Appl. No.: 13/965,990

(22) Filed: Aug. 13, 2013

(30) Foreign Application Priority Data
Aug. 15, 2012 (JP) 2012-180107

(51) Int. Cl. B23D 57/02

(52) U.S. Cl. CPC B23D 57/023
USPC 30/383

(57) ABSTRACT

A chain saw has a drive shaft which drives the saw chain, an electric motor which imparts a rotational force to the drive shaft, a main body housing which incorporates the electric motor, a battery which is detachably attached to the main body housing, a battery guard which supports a bottom surface of the battery, and a hook which is provided in a hook accommodating portion on a bottom surface side of the battery guard so as to be freely drawn out to the rear. A pillar-like portion is formed within the battery guard in a position lying further forwards than the hook accommodating portion, and bent-back portions of the hook are brought into engagement with the pillar-like portion.

### CROSS-REFERENCE TO RELATED APPLICATIONS

This application claims priority from Japanese Patent Application No. 2012-180107 filed on Aug. 15, 2012, the entire subject-matter of which is incorporated herein by reference.

### TECHNICAL FIELD

The present invention relates to a chain saw and more particularly to an electric-powered chain saw which uses a battery (e.g., a single battery or a battery pack) as a power supply for an electric motor.

### BACKGROUND

In recent years, for chain saws, there is an increasing tendency to propose electric-powered chain saws which use a battery or batteries as a power supply for an electric motor. When compared with chain saws which use as a power source a two-cycle or four-cycle internal combustion engine, electric-powered chain saws are advantageous in that they produce less noise and obviate the necessity of spending time dealing with gasoline.

On the other hand, in using chain saws, there is an opportunity to use a chain saw on a tree, and in this case, the chain saw is hoisted up to a higher position on the tree using a rope for use and is then hoisted down to the ground after use. Thus, there are some chain caws which are provided with a hook for this purpose. However, when a hook is formed protruding from a chain saw, there is caused a risk that the hook comes into contact with the body of an operator or surroundings or the chin saw is caught at the hook.

Further, when using the chain saw to cut a cutting object, chips may be scattered from a saw chain side toward a rear at a bottom surface side of a main body of the chain saw. Still further, there may be caused a problem where the bottom surface of the main body may contact the cutting object.

JP-A-2009-279884 discloses one example of the chain saw provided with the hook.

### SUMMARY

The invention has been made in view of these situations, and an object thereof is to provide a chain saw having a hoisting hook which is easy to be used without causing any interruption to a user or surroundings when it is not in use.

According to one illustrative aspect of the invention, there is provided a chain saw comprising: a main body housing; a guide bar which extends in a frontward direction of the main body housing; a saw chain configured to revolve along the guide bar; a drive shaft configured to drive the saw chain; an electric motor configured to impart a rotational force to the drive shaft; a battery configured to be detachably attached to the main body housing; and a battery guard configured to cover part of a bottom surface of the battery.

Incidentally, arbitrary combinations of the above-described constituent elements and changes in representation of the invention with respect to method and system are also effective as embodiments of the invention.

According to the illustrative aspects of the chain saw of the invention, since the hook is provided on the bottom surface side of the battery guard which supports the bottom surface of the battery, the hook does not interrupt the operation of the chain saw when not in use and can be used effectively in hoisting up and down the chain saw using a rope or the like.

### BRIEF DESCRIPTION OF THE DRAWINGS

FIGS. 1A and 1B show diagrams depicting a chain saw according to an embodiment of the invention, in which FIG. 1A is a left side view of the chain saw with a hook accommodated state shown partially in section, and FIG. 1B is a perspective view of an essential part in relation to a hook which is accommodated;

FIGS. 2A-2B show diagrams depicting the chain saw according to the embodiment of the invention, in which FIG. 2A is a left side view of the chain saw with a hook drawn-out state shown partially in section, and FIG. 2B is a perspective view of the essential part in relation to the hook which is drawn out;

FIGS. 3A-3B show diagrams depicting the chain saw according to the embodiment, in which FIG. 3A is a left side view of the chain saw with a switch state partially shown in section which results when no external force is applied to a hand guard, and FIG. 3B is a left side view of the chain saw with a switch state shown partially in section which results when the hand guard oscillates as a result of an application of an external force thereto;

FIG. 4 is a perspective view of the chain saw of the embodiment; and

FIG. 5 is a circuit diagram according to the embodiment.

### DETAILED DESCRIPTION

Hereinafter, a preferred embodiment of the invention will be described in detail by reference to the drawings. It should be noted that like reference numerals will be given to the same or like constituent elements, members, treatments, or the like so as to omit the repetition of similar descriptions as required. Additionally, the embodiment is an example of the invention and is not intended to limit the invention, and hence, all the characteristics that are described in the embodiment or combinations thereof are not always essential to the invention.

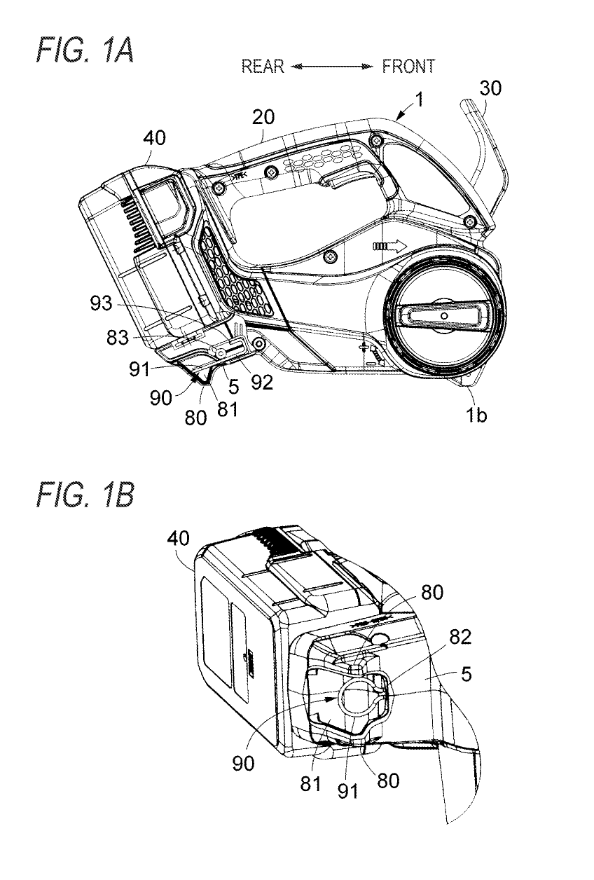

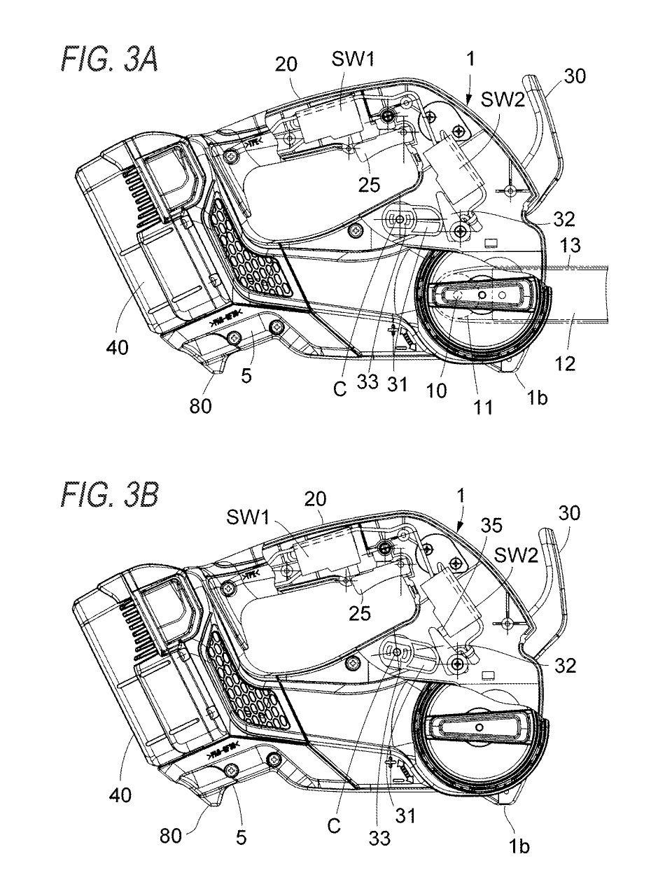

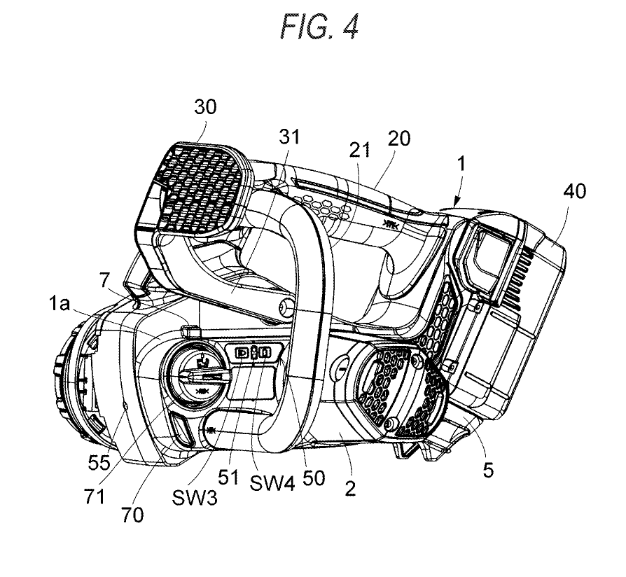

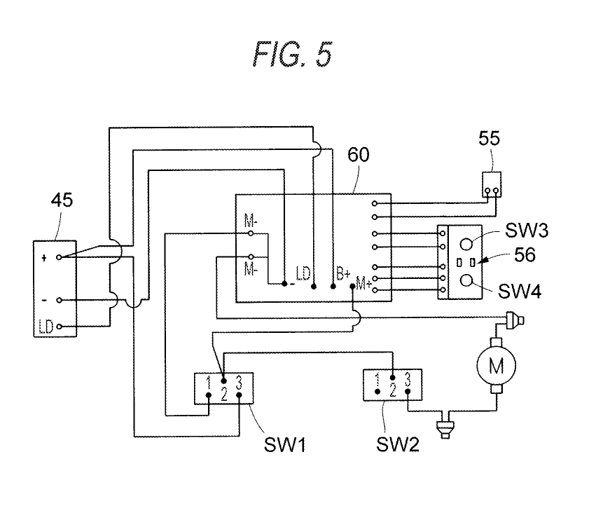

In FIGS. 1 to 5, a main body housing 1 has a motor case 2 provided on a right side surface so as to protrude therefrom as an integral part thereof as shown in FIG. 4. An electric motor M shown in FIG. 5 is accommodated (incorporated) in the motor case 2. A drive shaft 10 which is driven to rotate by the motor M and a sprocket 11 secured to the drive shaft 10 are provided on a left side surface of the main body housing 1 (indicated in broken lines in FIG. 3A). When a chain saw is used, a guide bar 12 is attached to a bolt of the main body housing 1 so as to protrude to the front of the main body housing 1. A saw chain 13 is wound around the sprocket 11 and the guide bar 12 (indicated by imaginary lines in FIG. 3A), and the saw chain 13 is driven to run along the guide bar 12 by the sprocket 11. Since this configuration is known, a detailed description thereof will be omitted here.

As shown in FIG. 4, a top handle 20 is formed integrally on an upper portion of the main body housing 1, and a front handle 21 is provided on a right side surface of the main body housing 1 so as to protrude therefrom. Normally, an operator grips the top handle 20 with his or her right hand and grips an upper portion (a substantially horizontal portion) of the front handle 21 with his or her left hand. In addition, a hand guard 30 for protecting the hand of the operator is disposed near a front side of the front handle 21. An arm portion 31 extends integrally from the hand guard 30 to the rear and is supported on the main body housing 1 so as to oscillate freely on an oscillating shaft (a rotational center C). A battery guard 5 is provided at a rear portion of the main body housing 1 so as to extend integrally, and a battery 40 is detachably attached to a rear end face of the main body housing 1 above the battery guard 5. The battery 40 is caused to slide down from an obliquely upper portion along a rail formed on the main body housing 1 so as to be inserted into a predetermined position on the main body housing 1 for attachment thereto, whereby terminals are connected to each other. The battery guard 5 extends in a direction which is substantially at right angles to the sliding direction of the battery 40 so as to be situated at a front side of the battery 40 as viewed in the attaching direction of the battery 40. An elastic member (made of rubber, for example) is affixed to a side of the battery guard 5 which lies to face the battery 40, and when the battery 40 is attached to the main body housing 1, the elastic member is held between the battery 40 and the battery guard 5, whereby the battery 40 can be held to the main body housing 1 in a stable fashion. Further, the battery guard 5 is able to guard a bottom surface of the battery 40.

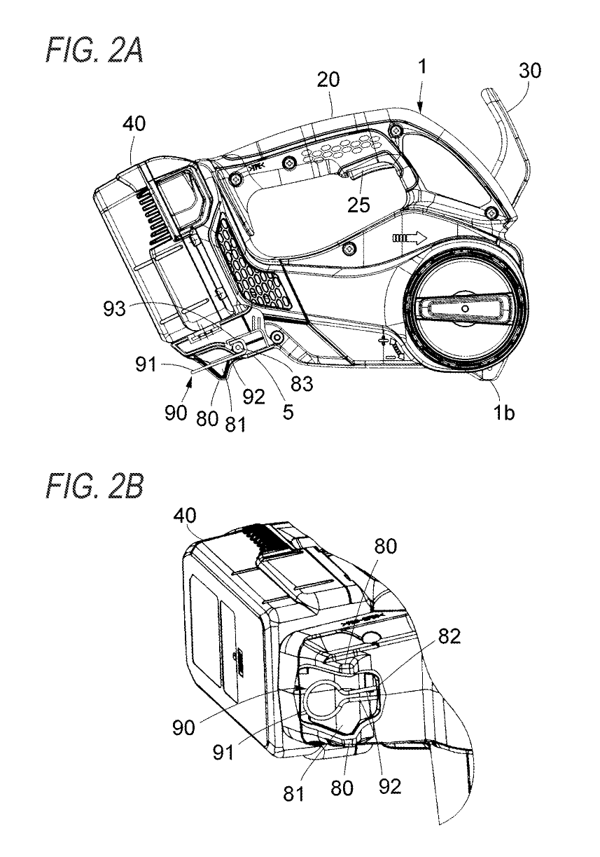

As shown in FIGS. 1A, 1B and 2A, 2B, a front lower portion of the main body housing 1 makes up a leg portion 1b, and a lower portion of the battery guard 5 makes up a pair of leg portions 80. The leg portions 80 protrude downwards from left and right sides of a bottom surface of the battery guard 5. Accordingly, the battery guard 5 has the leg portions 80 at a bottom side thereof, so that a stability of the chain saw when being placed on the ground can be improved. A hook accommodating portion 81 is formed between the left and right leg portions 80. This hook accommodating portion 81 is a recessed groove which is opened at a rear end of the battery guard 5 on a bottom surface side thereof. Then, a hook 90 is provided within the hook accommodating portion 81 so as to be drawn out freely to the rear.

Specifically, the hook 90 has a substantially circular ring-shaped portion 91, straight-line portions 92 which extend to the front individually from both ends of the ring-shaped portion 91 and bent-back portions 93 which are formed at distal end portions of the straight-line portions 92. On the other hand, the battery guard 5 has a slit-shaped draw-out hole 82 at the front of the hook accommodating portion 81 so that the straight-line portions 92 of the hook 90 are allowed to pass therethrough. Additionally, a pillar-like portion (a boss) 83 is formed within the battery guard 5 in a position lying further forwards than the hook accommodating portion 81. The battery guard 5 is formed integrally with the main body housing 1 and is made up of two left and right halved molded members of resin or the like. The hook 90 is assembled to be disposed in an interior of the battery guard 5 in such a state that the left and right molded members of the battery guard 5 are separated from each other. When the hook 90 is used, a finger of a user is hooked in the ring-shaped portion 91 to draw the straight-line portions 92 out of the slit-shaped draw-out hole 82 to thereby move the ring-shaped portion 91 to a position where the ring-shaped portion 91 protrudes from the hook accommodating portion 81. The straight-line portions 92 are drawn out until the bent-back portions 93 are hooked on the pillar-like portion 83 within the battery guard 5. Thus, the drawing out amount of the straight-line portions 92 is regulated. The straight-line portions 92 of the hook 90 are shaped so as to be spaced apart wider from each other as they extend away from the ring-shaped portion 91 as shown in FIG. 2B. Therefore, in a hook accommodated state shown in FIG. 1B, the pair of straight-line portions 92 are spaced apart wide from each other in the interior of the battery guard 5, whereby the hook accommodated state where only the ring-shaped portion 91 is exposed within the hook accommodating portion 81 can be held as long as no external force is applied to the hook 90. In addition, when the ring-shaped portion 91 is drawn out to the rear from the hook accommodated state shown in FIG. 1B to produce a hook drawn out state (a hook in-use state) shown in FIG. 2B, the pair of straight-line portions 92 is biased in a direction in which the straight-line portions 92 move apart from each other, whereby the straight-line portions 92 are brought in contact with left and right edges of the slit-shaped draw-out hole 82, respectively, to thereby maintain the hook drawn out state. In the drawn out state, a rope or the like is passed through the hook 90 so that the chain saw can be hoisted up and down, or the like.

A trigger 25 is attached to a lower surface side of the top handle 20, and a switch SW1, which is on when the trigger 25 is pulled, is fixedly disposed within the main body housing 1. Additionally, a switch SW2 is fixedly disposed within the main body housing 1, and this switch SW2 stops energizing the motor M when the hand guard 30 oscillates as a result of an external force being applied thereto. As shown in a circuit diagram of FIG. 5, the switch SW1, the switch SW2 and the motor M are connected in series between a positive terminal and a negative terminal of a terminal 45 which are connected to a positive terminal, a negative terminal and an LD terminal (a signal indicating a state of the battery) of the battery 40.

As shown in FIGS. 3A, 3B, a small arm 31 is secured to an oscillating shaft which rotates together with the hand guard 30. In addition, an oscillating piece 32 is disposed between the small arm 31 and the switch SW2, and this oscillating piece 32 is secured pivotally (attached rotatably) to the main body housing 1 at one end portion thereof. The small arm 31 and the oscillating piece 32 function as a movable member which moves in association with the oscillating shaft. A spring 33 is provided on the periphery of the oscillating shaft, and in FIGS. 3A and 4 which show a state in which no external force is applied to the hand guard 30 (a brake inoperative state), the hand guard 30 is in an upper position. As this occurs, an operating portion 35 of the switch SW2 is kept pressed on by the oscillating piece 32 since the oscillating piece 32 is pressed by the small arm 31 to thereby rotate in a rightward rotating direction as shown in FIG. 3A. Namely, the switch SW2 is kept in an ON state, in which the motor M can be energized.

On the other hand, when a situation occurs in which a kickback is produced while the chain saw is being used and the hand guard 30 is pushed down by the back of the left hand of the user, the hand guard 30 oscillates in a direction in which an upper end is lowered as shown in FIG. 3B (a brake operational state), and the oscillating piece 32 is no more pressed on by the small arm 31, whereby the operating portion 35 of the switch SW2 is kept protruding (an inoperative state), and the switch SW2 is off. As this occurs, in the event that the kickback is so strong that the hand guard 30 is moved excessively, there are fears that mechanisms surrounding the oscillating shaft which moves in association with the movement of the hand guard 30 are damaged or negatively influenced. Therefore, a stopper 7 is provided on a step portion 1a on a right side surface of the main body housing 1 as shown in FIG. 4. The stopper 7 is positioned apart from the oscillating shaft (the rotational center C). The stopper 7 may be a separate member which is fixed to the step portion 1a or may be formed in advance integrally with part of the main body housing 1. By the arm portion 31 of the hand guard 30 being brought into abutment with the stopper 7, an oscillating range of the hand guard 30 is restricted.

As shown in FIG. 4, a control and display panel 50 is provided on the right side surface of the main body housing 1, and this control and display panel 50 includes a light control switch SW3, a battery charged state indicating switch SW4 and a battery charged state indicating portion 51. The control and display panel 50 is preferably disposed in such a place where it is easily visible to the user and the switches are not on or off erroneously. Specifically, the control and display panel 50 is disposed on the right side surface of the main body housing 1 where the substantially U-shaped front handle 21 is provided in a position lying near the motor case 2 and corresponding to a lower position on the front handle 21. The light control switch SW3 and the battery charged state indicating switch SW4 of the control and display panel 50 are a tact switch and are connected to a controller 60 shown in FIG. 5. An LED light 55, which functions as an illumination means and is disposed on a front surface of the main body housing 1, is illuminated when the light control switch SW3 is on. When the battery charged state indicating switch SW4 is on, a battery charged state indicating lamp 56 of the battery charged state indicating portion 51 is turned on or turned off according to a charged state of the battery 40. An LD terminal of the terminal 45, which is connected to the LD terminal of the battery 40, is intended to output a signal indicating a state (for example, an over-discharged state) of the battery 40 to the controller 60. In addition, a circuit board on which the controller 60 and the like are mounted is disposed near a battery attaching surface at a rear portion of the main body housing 1.

An oil tank is incorporated in the main body housing 1 which holds lubrication oil for use in lubrication of the saw chain 13, and an oil tank cap 71 is provided on the right side surface of the main body housing 1 for refilling the oil tank with lubrication oil. Additionally, an oil tank residual amount display portion 70, which is intended to indicate a residual oil amount in the oil tank, is disposed at a front portion (near the LED light 55) of the right side surface of the main body housing 1 so as to be visible to the user. When the light control switch SW3 is on, the LED light 55 disposed on the front surface of the main body housing 1 is turned on to be illuminated. Thus, the LED light 55 is arranged so that a beam of light emitted from the LED light 55 is incident on the oil tank residual amount display portion 70 by way of a translucent portion of the main body housing 1 so as to illuminate the oil tank residual amount display portion 70 from an inside thereof.

An overall operation of the embodiment will be described. When the trigger 25 is pulled with the saw chain 13 wound around the sprocket 11 and the guide bar 12 as shown in FIG. 3A, the switch SW1 is on, and electric power is supplied from the battery 40 to the electric motor M by way of the switch SW2 which is normally kept on, whereby a predetermined cutting operation is performed.

When there is caused a situation in which a kickback is produced while the chain saw is being used, whereby the hand guard 30 is pushed down by the back of the left hand of the user, the hand guard 30 is oscillated in the direction in which the upper end of the hand guard 30 is lowered as shown in FIG. 3B. Then, the oscillating piece 32 is no more pressed on by the small arm 31, and the operating portion 35 of the switch SW2 protrudes (into the inoperative state), whereby the switch SW2 is off. As a result, energizing the motor M is interrupted irrespective of the state of the trigger 25, and the motor M stops. As this occurs, it is possible to apply a related-art mechanical brake to an output shaft of the motor M or a driving shaft of the sprocket 11 in association with the oscillation of the hand guard 30.

As to the hook 90 on the bottom surface side of the battery guard 5, when not in use, the ring-shaped portion 91 of the hook 90 is kept within the hook accommodating portion 81 between the pair of leg portions 80 of the battery guard 5 as shown in FIGS. 1A, 1B. With the hook 90 kept in this position, a cutting operation or the like is not interrupted by the hook 90. In addition, when the hook 90 is used, the ring-shaped portion 91 is drawn out to the rear, whereby part of the ring-shaped portion 91 protrudes from the hook accommodating portion 81 between the pair of leg portions 80 of the battery guard 5 as shown in FIGS. 2A, 2B (refer to FIG. 2A), facilitating work of passing a rope or the like through the ring-shaped portion 91.

As to the control and display panel 50, when the light control switch SW3 is on, the LED light 55 is illuminated by way of the controller 60 so as to illuminate an area ahead of the chain saw, and the oil tank residual amount indicating portion 70 can also be illuminated from the inside thereof by light emitted sideways from the LED light 55, this allowing the user to easily recognize the residual amount of oil by looking at the oil tank residual amount indicating portion 70.

When the battery charged state indicating switch SW4 on the control and display panel 50 is on, the battery charged state indicating lamp 56 of the battery charged state indicating portion 51 is turned on or turned off by way of the controller 60 according to the charged state of the battery 40. By doing so, the user can recognize the charged state of the battery 40 by looking at the battery charged state indicating lamp 56.

According to the embodiment, the following working effects can be provided.

(1) The hook accommodating portion 81 is formed on the bottom surface side of the battery guard 5 so as to be opened at the rear end, and the hook 90 is provided in the hook accommodating portion 81 so as to be drawn out freely to the rear. Therefore, in the hook accommodated state, the hook 90 is accommodated within the hook accommodating portion 81 and is hence disposed so as not to interrupt the operation of the chain saw. Additionally, the battery 40 does not interrupt the hoisting up and down of the chain saw using the hook 90, and the chain saw can be hoisted up and down while it is kept oriented substantially vertical. Additionally, even when the hook 90 is kept accommodated within the hook accommodating portion 81, the hook 90 is faced to the position where the whole of the ring-shaped portion 91 can be visualized and operated from the outside, thereby making it possible to facilitate the drawing out operation of the hook 90.

(2) The hook 90 includes the substantially circular ring-shaped portion 91, the straight-line portions 92 which extend to the front from both ends of the ring-shaped portion 91, respectively, and the bent-back portions 93 which are formed at the distal end portions of the straight-line portions 92 and the bent-back portions 93 are adapted to be hooked on the pillar-like portion 83 within the battery guard 5. Thus, the hook 90 can be prevented from being dislocated from the hook accommodating portion 81 to fall, and the hook 90 can be held so as to freely move back and forth.

(3) The straight-line portions 92 of the hook 90 are shaped so as to be spaced apart wider from each other as they move away from the ring-shaped portion 91. Therefore, in the hook accommodated state shown in FIG. 1B, the pair of straight-line portions 92 are spaced apart wide from each other in the interior of the battery guard 5. Thus, the hook accommodated state can be held in which only the ring-shaped portion 91 is exposed within the hook accommodating portion 81, as long as no external force is applied to the hook 90. On the other hand, when the ring-shaped portion 91 is drawn out to the rear from the hook accommodated state shown in FIG. 1B to obtain the hook drawn out state (the hook in-use state) shown in FIG. 2B, the pair of straight-line portions 92 are biased in the direction in which they are spaced apart wide from each other so as to be brought into contact with the left and right edges of the slit-shaped draw-out hole 82, whereby the hook drawn out state can be maintained by means of friction produced therebetween.

While the invention has been described based on the embodiment thereof, it can be understood by those skilled in the art that various modifications can be made to the respective constituent elements and treatment processes described in the embodiment without departing from the scope of the claims.

What is claimed is:

1. A chain saw comprising:
a main body housing;
a guide bar which extends in a frontward direction of the main body housing;
a saw chain configured to revolve along the guide bar;
a drive shaft configured to drive the saw chain;
an electric motor configured to impart a rotational force to the drive shaft;
a battery configured to be detachably attached to the main body housing; and
a battery guard configured to cover part of a bottom surface of the battery.

2. The chain saw according to claim 1,
wherein the battery is configured to slide down from above the main body housing to be attached thereto.

3. The chain saw according to claim 1,
wherein the battery guard has an elastic member which is provided between the battery guard and the battery.

4. The chain saw according to claim 1,
wherein the battery guard has a leg portion at a bottom side thereof.

5. The chain saw according to claim 1,
wherein the battery guard has a hook.

6. The chain saw according to claim 5,
wherein a hook accommodating portion is formed in the battery guard, and
wherein the hook is provided in the hook accommodating portion so as to be freely drawn out to a rearward direction.

7. The chain saw according to claim 5,
wherein a pillar-like portion is provided at a front side of the hook accommodating portion, and
wherein bent-back portions of the hook are in engagement with the pillar-like portion.

8. The chain saw according to claim 5,
wherein the hook comprises:
a ring-shaped portion having a substantially circular shape; and
straight-line portions which extend in the frontward direction from both ends of the ring-shaped portion, respectively, and
wherein the bent-back portions are formed at distal end portions of the straight-line portions.

9. The chain saw according to claim 5,
wherein the battery guard has a draw-out hole at the front side of the hook accommodating portion configured to pass the straight-line portions of the hook therethrough, and
wherein the straight-line portions are configured to be movable to pass through the draw-out hole.

10. The chain saw according to claim 5,
wherein the straight-line portions of the hook are shaped so as to be spaced apart wider from each other as they move away from the ring-shaped portion.

11. The chain saw according to claim 5,
wherein the hook accommodating portion is a recessed groove which is opened at a rear side on a bottom surface side of the battery guard.
